(19) United States
(12) Patent Application Publication
(10) Pub. No.: US 2025/0298716 A1
(43) Pub. Date: Sep. 25, 2025

(54) Run Time Firmware Calibration

(71) Applicants: Advanced Micro Devices, Inc, Santa Clara, CA (US); ATI Technologies ULC, Markham (CA)

(72) Inventors: Joshua Taylor Knight, Georgetown, TX (US); William Robert Alverson, Del Valle, TX (US); Grant Evan Ley, Eden, UT (US); Jerry Anton Ahrens, Jr., Sister Bay, WI (US); Anil Harwani, Austin, TX (US); Mustansir Moiz Pratapgarhwala, Austin, TX (US); Adam Neil Calder Clark, Victoria (CA); Amitabh Mehra, Fort Collins, CO (US)

(21) Appl. No.: 18/615,157

(22) Filed: Mar. 25, 2024

(51) Int. Cl. G06F 11/34; G06F 11/30

(52) U.S. Cl. CPC G06F 11/3414; G06F 11/3058; G06F 11/3089

(57) ABSTRACT

Run time firmware calibration is described. An example system includes one or more hardware components and a system manager. The system manager is configured to operate the one or more hardware components according to a tuning configuration, execute a calibration workload while adjusting one or more parameters of the tuning configuration, generate an updated tuning configuration that includes adjusted values of the one or more parameters, and operate the one or more hardware components according to the updated tuning configuration.

### BACKGROUND

Typically, computing systems are tuned to operate according to a set of potential configurations (e.g., high performance, low power, etc.) via hard-coded tuning parameters (e.g., maximum voltage values, power and current limiters, temperature ranges, etc.). In general, hard-coded tuning parameters are set to nominal values that can accommodate a range of possible system configurations and/or operating conditions (e.g., ambient temperature, variability in cooling solution, workload being run etc.). However, such nominal values designed for the complete operational space possible are also typically not optimal for any one of the possible system configurations and/or operating conditions subsets.

### BRIEF DESCRIPTION OF THE DRAWINGS

FIG. 1 is a block diagram of a non-limiting example system having a memory and a controller operable to implement run time firmware calibration.

FIG. 2 is a non-limiting example diagram of a frequency response curve of a component operating under a first set of conditions.

FIG. 3 is a non-limiting example diagram of a frequency response curve of a component operating under a second set of conditions.

FIG. 4 is a non-limiting example diagram of a frequency response curve of a component operating under a third set of conditions.

FIG. 5 depicts a procedure in an example implementation of run time firmware calibration.

### DETAILED DESCRIPTION

Computing systems typically use a compromise algorithm to manage performance and power consumption of hardware components. For example, a power management algorithm can set a high power budget for a component, e.g., by raising a maximum voltage limit, to enable the component to operate at a higher frequency by increasing a peak-to-peak voltage corresponding to high and low logic signals. However, increasing the power budget also leads to increased power consumption and leakage (in the form of heat) which could also reduce the maximum clock frequency selected by the compromise algorithm for operating the component so that a cooling solution (e.g., fan) employed by the system is able to maintain a suitable, safe, operating temperature of the component at the maximum clock frequency and the power budget. To that end, computing systems typically employ one or more sets of tuning parameters to manage performance against energy efficiency while accommodating different use scenarios, e.g., for high performance workloads and low performance workloads.

Various hardware components, such as processor and memory devices, are designed to accommodate a wide variety of system configurations, environments, and/or workloads. Currently, the configuration space for computing systems is either too variable or too specific to allow optimally tuning a different system response (e.g., in default compiled firmware) for every possible use scenario. For instance, due to space limitations, storing different tuning parameter values for each possible use case, e.g., combination of components, cooling solutions, workloads, ambient temperatures, etc., at the product definition stage could be impractical. Thus, many conventional solutions store default tuning parameters that are set to nominal values which accommodate a wide range of system configurations but are not optimal for any one particular system configuration and/or operating condition.

To solve these problems, run time firmware calibration to a user system is described. In contrast to conventional approaches, an example system manager described herein initially operates one or more hardware components using a default tuning configuration. The system manager then executes, at run time, a calibration workload while adjusting one or more parameters (e.g., maximum voltage, etc.) of the default tuning configuration. In examples, the calibration workload includes a stress workload, a test pattern, a de-rated workload, or any other test workload. During execution of the calibration workload, the system manager receives data produced by a plurality of sensors over time (e.g., temperatures, voltages, frequencies, etc.) and logs this data. The system manager then uses the data to select adjusted values for the one or more parameters that account for specific operation conditions and other configuration properties of the system (e.g., cooling system thermal efficiency, ambient temperature, ambient humidity, etc.). For instance, compared to nominal values in the default tuning configuration, the adjusted values could more optimally tune compromise algorithms (e.g., frequency management, thermal management, power management, etc.) used to manage the performance and energy efficiency of the system under the current actual operating conditions. The example system manager is further configured to generate an updated tuning configuration that includes the adjusted values of the one or more parameters.

In various examples, the system manager is further configured to adjust operation of the one or more hardware components of the system dynamically, such as by communicating a change signal to adjust a frequency, voltage, and/or timings at which components of the system operate, according to the updated tuning configuration. Notably, the system manager adjusts such operation based, in part, on conditions detected by the sensors (e.g., temperature, voltage, clock frequency, etc.) and based on one or more adjustable parameters to ensure the system is operating at an optimal point for those conditions.

For example, the system manager uses one or more parameters, as adjusted at the time, to set a voltage limit or a supplied power limit at which a component is expected to achieve a maximum clock frequency or optimal performance per/watt or other characteristic under current operating conditions (e.g., ambient temperature, etc.). In contrast to conventional techniques where an algorithm that controls a system response to changing conditions is static, the described techniques enable a thermal management algorithm, frequency management algorithm, and/or power management algorithm to be adjusted dynamically by modifying one or more parameters, such as terms of an underlying thermal management algorithm used by a system manager to respond to detected thermal events, voltage events, efficiency response curves (e.g., slope, etc.), constants, values, and so forth to ensure the system operates at the optimal point given the detected conditions.

Moreover, at least one example advantage of the described techniques is that they can reduce the space required to store many different sets of tuning parameters at the product definition stage. Another example advantage is that the described techniques enable fine-tuning optimal tuning parameter values suitable for each specific system configuration (e.g., cooling system thermal efficiency, manufacturing variabilities, etc.), workload requirements, and other operating conditions (e.g., ambient temperature, etc.) of a specific user system. In order for conventional approaches, which assume a certain set of operating conditions (e.g., ambient temperature, cooling solution thermal efficiency), to be more accurate, such techniques would need to increase the number of predefined and stored tuning configurations which might not be possible due to space limitations, or would need advanced knowledge of the specific workload needs, system configuration, and/or operating conditions of a user system which might not be available when a component is assembled or manufactured or when the default tuning algorithms are designed.

In some aspects, the techniques described herein relate to a system including: one or more hardware components including a processor; and a system manager, the system manager configured to: operate the one or more hardware components according to a tuning configuration; execute, using the one or more hardware components, a calibration workload while adjusting one or more parameters of the tuning configuration; generate an updated tuning configuration that includes adjusted values of the one or more parameters; and operate the one or more hardware components according to the updated tuning configuration.

In some aspects, the techniques described herein relate to a system, wherein the system manager is further configured to adjust, during execution of the calibration workload, the one or more parameters to values within a predefined range.

In some aspects, the techniques described herein relate to a system, wherein the one or more hardware components include a memory.

In some aspects, the techniques described herein relate to a system, wherein the one or more parameters include at least one of a controller coefficient, a voltage limit, a hysteresis threshold, or an efficiency response.

In some aspects, the techniques described herein relate to a system, further including a sensor coupled to the one or more hardware components, wherein the system is further configured to: based on measurements from the sensor collected during execution of the calibration workload, select the adjusted values of the one or more parameters for the updated tuning configuration.

In some aspects, the techniques described herein relate to a system, wherein the sensor includes a temperature sensor configured to measure a temperature of the processor.

In some aspects, the techniques described herein relate to a system, wherein the system manager is further configured to: detect a change to a configuration of the one or more hardware components; and trigger execution of the calibration workload in response to detecting the change.

In some aspects, the techniques described herein relate to a system, further including a sensor configured to measure an environment of the system, wherein the system manager is further configured to: based on measurements from the sensor, detect a change in an environmental condition associated with the tuning configuration; and schedule execution of the calibration workload based on the change in the environmental condition exceeding a threshold.

In some aspects, the techniques described herein relate to a method including: operating one or more hardware components according to a tuning configuration; executing a calibration workload using the one or more hardware components while adjusting one or more parameters of the tuning configuration; generating an updated tuning configuration that includes adjusted values of the one or more parameters; and adjusting operation of the one or more hardware components according to the updated tuning configuration.

In some aspects, the techniques described herein relate to a method, further including: receiving input indicative of a request to update the tuning configuration; and trigger execution of the calibration workload in response to receipt of the input.

In some aspects, the techniques described herein relate to a method, further including: during execution of the calibration workload, adjusting the one or more parameters to values within a predefined range.

In some aspects, the techniques described herein relate to a method, wherein the one or more hardware components include a memory, the memory storing an indication of the predefined range.

In some aspects, the techniques described herein relate to a method, wherein the one or more parameters include at least one of a controller coefficient, a voltage limit, a hysteresis threshold, or an efficiency response.

In some aspects, the techniques described herein relate to a method, further including: based on sensor measurements collected from a sensor during execution of the calibration workload, selecting the adjusted values of the one or more parameters for the updated tuning configuration.

In some aspects, the techniques described herein relate to a method, wherein the sensor includes a temperature sensor configured to measure temperature of the one or more hardware components.

In some aspects, the techniques described herein relate to a method, further including: detecting a change to a configuration of the one or more hardware components; and scheduling execution of the calibration workload in response to detecting the change.

In some aspects, the techniques described herein relate to a method, further including: based on measurements from a sensor, detecting a change in an environmental condition associated with the tuning configuration; and scheduling execution of the calibration workload based on the change in the environmental condition exceeding a threshold.

In some aspects, the techniques described herein relate to a device including: a processor; a memory; and a system manager configured to: operate at least one of the processor or the memory according to a tuning configuration; execute, using the at least one of the processor or the memory, a calibration workload while adjusting one or more parameters of the tuning configuration; generate an updated tuning configuration that includes adjusted values of the one or more parameters; and adjust operation of the at least one of the processor or the memory according to the updated tuning configuration.

In some aspects, the techniques described herein relate to a device, wherein the system manager is further configured to: during execution of the calibration workload, adjust the one or more parameters to values within a predefined range.

In some aspects, the techniques described herein relate to a device, wherein the one or more parameters include at least one of a controller coefficient, a voltage limit, a hysteresis threshold, or an efficiency response.

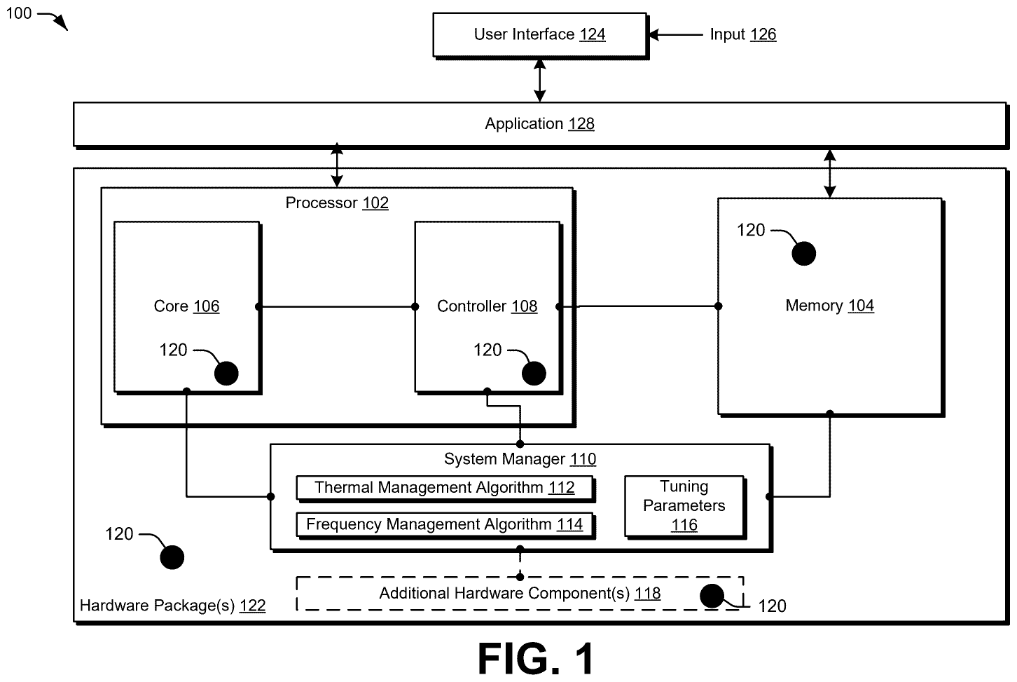

FIG. 1 is a block diagram of a non-limiting example system 100 having a memory and a controller operable to implement run time firmware calibration. In this example, the system 100 includes processor 102 and memory 104. In at least one implementation, the processor 102 includes a core 106 and a controller 108. In the illustrated example, the system 100 also includes a system manager 110, which controls the power provided to one or more components of the system 100 according to a thermal management algorithm 112, a frequency management algorithm 114, and tuning parameters 116. In the illustrated example, the system 100 also includes additional hardware component(s) 118. A non-exhaustive list of example additional hardware components 118 includes cache, secondary storage, semiconductor intellectual property (IP) core, voltage regulator, clock generator (e.g., oscillator and circuitry configured to control a frequency of a clock signal output from the clock generator), among other possibilities. In various examples, the system 100 includes one or more optional and/or additional hardware component(s) 118.

The processor 102, the memory 104, and optionally the additional hardware component(s) 118 are operable to implement one or more applications 128, including, for instance, a system management application that presents information about and/or supports dynamic adjustment of: the thermal management algorithm 112 and/or the frequency management algorithm 114 to control power supplied to various hardware of the system 100 based on one or more conditions detected by sensors 120.

In the illustrated example, the above-described components (e.g., the processor 102, the memory 104, the additional hardware component(s) 118, etc.) are included in a hardware package 122. An example of the hardware package 122 includes but is not limited to a printed circuit board (PCB), such as a motherboard, and/or a system-on-chip (SoC). In at least one variation, components of the system 100 are implemented using more than one hardware package, such as using more than one printed circuit board (PCB), semiconductor die (e.g., chiplets), etc. It is to be appreciated also, that in at least one variation, the system 100 does not include one or more of the depicted components and/or includes different components without departing from the spirit or scope of the described techniques.

In accordance with the described techniques, the processor 102 and the memory 104 are coupled to one another via a wired or wireless connection. The core 106 and the controller 108 are also depicted coupled to one another via one or more wired or wireless connections. The other components of the system 100 are connectable via wired and/or wireless connections. Example wired connections include, but are not limited to, memory channels, buses (e.g., a data bus), interconnects, through silicon vias, traces, and planes. Other example connections include optical connections, fiber optic connections, and/or connections or links based on quantum entanglement.

Examples of devices or apparatuses in which the system 100 is implemented include, but are not limited to, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

The processor 102 is an electronic circuit that performs various operations on and/or using data in the memory 104. Examples of the processor 102 include, but are not limited to, a central processing unit (CPU), a graphics processing unit (GPU), a field programmable gate array (FPGA), an accelerator, an accelerated processing unit (APU), and a digital signal processor (DSP), an inference engine, to name a few. The core 106 is a processing unit that reads and executes instructions (e.g., of a program), examples of which include to add, to move data, and to branch. Although one core 106 is depicted in the illustrated example, in variations, the processor 102 includes more than one core 106, e.g., the processor 102 is a multi-core processor.

The memory 104 is a device or system that is used to store information, such as for immediate use in a device, e.g., by the processor 102 or by an in-memory processor (not shown), which is referred to as a processing-in-memory component or PIM component. In one or more implementations, the memory 104 corresponds to semiconductor memory where data is stored within memory cells on one or more integrated circuits. In at least one example, the memory 104 corresponds to or includes volatile memory, examples of which include random-access memory (RAM), dynamic random-access memory (DRAM), synchronous dynamic random-access memory (SDRAM), static random-access memory (SRAM), and memristors.

The memory 104 is packaged or configured in any of a variety of different manners. Examples of such packaging or configuring include a dual in-line memory module (DIMM), an unbuffered DIMM (UDIMM), a small outline DIMM (SO-DIMM), a registered DIMM (RDIMM), a non-volatile DIMM (NVDIMM), a ball grid array (BGA) memory permanently attached to (e.g., soldered to) the hardware package 122 (or other printed circuit board) such as low-power double data rate (LPDDR), and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the memory 104 is configured as or includes a SO-DIMM or an RDIMM or UDIMM or LPDDR etc. according to one of the above-mentioned standards, e.g., DDR, DDR2, DDR3, DDR4, and DDR5.

Alternatively or in addition, the memory 104 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). The memory 104 is configurable in a variety of ways capable of supporting thermal management using an adjustable thermal management algorithm, frequency management using an adjustable frequency management algorithm, and/or receiving power or clock signals managed using such an adjustable algorithm.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the memory 104 is configurable in a variety of ways without departing from the spirit or scope of the described techniques.

The controller 108 is a digital circuit that manages the flow of data to and from the memory 104. By way of example, the controller 108 includes logic to read and write to the memory 104 and interface with the core 106, and in variations to interface with multiple cores and/or a processing-in-memory component (not shown). For instance, the controller 108 receives instructions from the core 106 which involve accessing the memory 104, and the controller 108 provides data from the memory 104 to the core 106, e.g., for processing by the core 106. In one or more implementations, the controller 108 is communicatively and/or topologically located between the core 106 and the memory 104, and the controller 108 interfaces with both the core 106 and the memory 104. In one or more implementations, the controller 108 is separate from the processor 102. Alternatively or additionally, the system 100 includes the controller 108 as part of the processor 102 and also includes at least one additional controller separate from the processor 102, e.g., a memory controller.

In one or more implementations, the system manager 110 includes or is otherwise configured to interface with one or more systems capable of updating operation of various components of the system 100, examples of such systems include but are not limited to an adaptive voltage scaling (AVS) system, an adaptive voltage frequency scaling (AVFS) system, and a dynamic voltage frequency system (DVFS). For example, the system manager 110 uses such systems to adjust settings (e.g., voltage, frequency, timings, etc.) at which the various components of the system operate. In one or more implementations, the system manager 110 is configured as a microcontroller disposed on a die running firmware to perform a variety of the operations discussed above and below.

In accordance with the described techniques, for instance, the system manager 110 is configured to adjust operation of one or more components of the system dynamically, such as by communicating a change signal to adjust a frequency, voltage, and/or timings at which components of the system operate. Further, the system manager 110 adjusts such operation based, in part, on conditions detected by the sensors 120 (e.g., temperature, humidity, voltage, frequency, etc.) and based on the thermal management algorithm 112 and/or the frequency management algorithm 114, namely, how the thermal management algorithm 112 and/or the frequency management algorithm 114 is adjusted at a time corresponding to the detected conditions.

Although the system manager 110 is depicted separately from the processor 102 and the memory 104, in one or more implementations, the system manager 110 is included as part of the processor 102, the memory 104, or the additional hardware component(s) 118. Alternatively or additionally, one or more components of the system 100 includes a component manager (not shown), which performs one or more of the operations described above and below as being performed by the system manager 110. By way of example, and not limitation, the processor 102 and the memory 104 each include a component manager, operable to implement thermal management and/or frequency management using a respective adjustable management algorithm. Although a firmware implementation is discussed above, in one or more variations, the system manager 110 is implemented using hardware in addition to or rather than firmware. In one example, for instance, the system manager 110 is implemented using hardware in a core.

In accordance with the described techniques, the system 100 also includes the sensors 120, e.g., temperature sensors, voltage sensors, frequency sensors, edge detectors, humidity sensors, etc. Although the sensors are depicted as being integral with various components of the system 100, in one or more implementations, a single component includes the plurality of sensors 120, e.g., the core 106 or the memory 104. Alternatively or additionally, any two or more components of the system 100 includes one or more sensors of the plurality of sensors 120. Thus, in various examples, the plurality of sensors 120 is integrated throughout the system 100 (or throughout an individual component) in a variety of ways without departing from the spirit or scope of the described techniques.

The tuning parameters 116 include parameters used by the thermal management algorithm 112 and/or the frequency management algorithm 114 to control the power supplied to the various components of the system 100 (e.g., processor 102, memory 104, additional hardware component(s) 118) in a manner that enables the supplied component to operate efficiently (e.g., at a certain clock frequency to facilitate processing a workload accurately and quickly without consuming unnecessary power). In general, a maximum clock frequency of a given component depends on the available power supply, which can be controlled by adjusting a maximum voltage corresponding to a logic high signal, in combination with the thermal efficiency of a cooling solution (e.g., fan, cold plate, etc.) used to maintain a temperature of the powered component within a safe operating range. The thermal efficiency of the cooling solution generally depends on various factors such as ambient temperature, cold plate characteristics, fan curve of a cooling fan, among other factors.

In examples, tuning parameters 116 include parameters such as voltage limits corresponding to different maximum clock frequencies, a voltage delta per degree Celsius for controlling a temperature of the component (e.g., via an AVFS control process), a frequency delta per millivolt for controlling the maximum clock frequency (e.g., via an AVFS control process), an efficiency response curve (e.g., frequency response versus power supplied, temperature response versus power supplied, etc.) used thermal management algorithm 112 and/or the frequency management algorithm 114 to select voltage limits, timings, etc., suitable for a certain workload, and so on. Due to complexity and interdependence of various tuning parameters 116 as well as current operating conditions (e.g., ambient temperature, etc.), in some examples, the tuning parameters 116 are determined experimentally by measuring various system responses (also referred to as efficiency responses) such as steady state frequency, temperature, power consumption, etc., during execution of a workload while iterating through a range of possible values for the parameters. For example, the measured tuning parameters 116 are stored as a tuning configuration that can be applied when executing future and/or similar workloads.

In conventional approaches, operation of components is managed based on a hard-coded set of tuning parameters 116, e.g., a default tuning configuration stored in system firmware, whose values are set during a product definition or design or testing stage prior to deployment and/or integration into a user system. For example, temperature, voltage, and/or frequency measurements obtained from the sensors 120 together with a default set of tuning parameters 116 describing an expected relationship between the various sensor readings are used by the thermal management algorithm 112 and/or the frequency management algorithm 114 as a basis for controlling voltage, clock frequency, hysteresis thresholds, and so on, of various components of the system. In operation, however, the default set of tuning parameters 116 which were selected on the basis of assumed operating conditions and component characteristics are generally not optimal for the actual operating conditions and/or component characteristics of a specific user system configuration of the component. Due to this, conventional approaches often throttle operation of one or more computing system components based on an incorrect view of an expected frequency response or temperature response, e.g., a voltage limit is increased excessively to achieve a higher maximum clock frequency could actually result in a lower achieved maximum operating clock frequency enforced to cool the components operating at a different ambient temperature than assumed when the default tuning parameter values were generated. This can lead to instability or damage of components during operation, degradation of system hardware over time, higher power consumption, and/or lower achieved maximum operating clock frequency than would be possible if more optimal voltage limit values were applied instead.

In contrast to conventional approaches, in one or more implementations, the system manager 110 executes a calibration workload, e.g., at run time or as an extra configuration step during a system boot process, using one or more hardware components of the system 100, e.g., the processor 102, the memory 104, and/or the additional hardware component(s) 118. During execution of the calibration workload, in examples, the system manager 110 adjusts one or more of the tuning parameters 116 used by the thermal management algorithm 112 and/or the frequency management algorithm 114 to values within a predefined range (e.g., a safe operating range of values defined by the manufacturer and/or stored in the hardware package(s) 122). For instance, an external tool (e.g., application 128, bios software, other software) provides the calibration workload to the processor 102, the memory 104, and/or the additional hardware component(s) 118; and sends a message to the system manager 110 to enter a test mode. In the test mode, the system manager 110 receives and logs data produced by the plurality of sensors 120 (e.g., temperatures, voltages, frequencies, etc.) over time while the calibration workload is executing and while iteratively applying different values of the one or more tuning parameters 116 (e.g., maximum voltage limit values (Vmax), hysteresis thresholds, etc.) to the thermal management algorithm 112 and/or the frequency management algorithm 114.

After iterating through the predefined range of values, the system manager 110 selects adjusted values of the tuning parameters 116 that would provide an optimal performance (e.g., highest maximum clock frequency, best power efficiency response, etc.) that accounts for current operating conditions (e.g., ambient temperature, ambient humidity, component manufacturing variability, etc.) of the specific configuration of the system 100 executing the calibration workload; and stores the adjusted values of the tuning parameters 116 as an updated tuning configuration for the system 100. In one or more implementations, the system manager 110 uses the thermal management algorithm 112 and/or the frequency management algorithm 114, as adjusted according to the updated tuning configuration, to operate the processor 102, the memory 104 and/or the additional hardware component(s) 118 when executing future workloads.

In one or more implementations, the thermal management algorithm 112 and/or the frequency management algorithm 114 uses the updated tuning parameters 116 to adaptively manage voltage and/or clock frequency settings applied to the processor 102, the memory 104, and/or the additional hardware component(s) 118. For example, the system manager 110 employs an AVFS algorithm to throttle the logic high voltage and/or the clock frequency of processor 102 or memory 104 within a range of values based on an efficiency response curve, frequency response curve, and/or temperature response curve indicated by the adjusted tuning parameters 116.

In contrast to conventional techniques where an algorithm that controls a system response to changing conditions is static, the described techniques enable the thermal management algorithm 112 and/or the frequency management algorithm 114 to be adjusted, e.g., based on user input 126, by an application 128, a particular workload being performed, current operating conditions (e.g., ambient temperature, humidity, etc.), and so forth. The thermal management algorithm 112 and/or the frequency management algorithm 114 is adjustable, for instance, by modifying one or more portions (e.g., parameters) of the algorithm, such as terms, weights, degree (e.g., linear, quadratic, etc.), constants, values, slopes, and so forth.

In one or more implementations, the system manager 110 detects a change to a configuration of the processor 102, memory 104, and/or the additional hardware component(s) 118); and triggers execution of the calibration workload in response to detecting the change. For example, if the system manager 110 detects (e.g., during boot up) that a new memory device is connected to the system 100, then the system manager 110 triggers or schedules execution of the calibration workload to adjust the tuning parameters 116 to more optimal values that account for the specific capabilities and/or properties of the new memory device.

In one or more implementations, the system manager 110 detects a change in an environmental condition associated with a previously stored tuning configuration; and schedules or triggers execution of the calibration workload based on the change in the environmental condition exceeding a threshold. For instance, if the currently stored values of the tuning parameters 116 were selected when the one or more components were tested at a different ambient temperature or humidity, then the system manager 110 executes the calibration workload to retune the tuning parameters 116 under the current operating conditions.

In one or more implementations, the system manager 110 schedules or triggers execution of the calibration workload in response to passage of a threshold amount of time. For example, the system manager 110 schedules a re-tuning process that includes executing the calibration workload every 30 days, 60 days, 90 days, or after passage of any other threshold amount of time from running a previous re-tuning process to update the tuning parameters 116.

In at least one variation, the system manager 110 exposes one or more interfaces (e.g., an application programming interface (API) and/or other user interface 124) configured to receive input 126 specifying adjustments to the algorithm 112 or 114 (e.g., one or more parameters of the algorithm) and to cause the system manager 110 to adjust the algorithm according to the input. Examples of adjustments include, but are not limited to, adding or removing one or more gain terms, adjusting deltas (e.g., maximum temperature difference), adjusting a slope (e.g., linear, polynomial, etc.) associated with using the algorithm to estimate detected events (e.g., temperatures and/or frequencies) and/or to control a response to detected events, adjusting an amount of history (e.g., of measurements) to store and use to determine system responses (e.g., a point in time versus a first interval of time versus a second, longer interval of time), and so forth. It is to be appreciated that in variations to the thermal management algorithm 112 and/or the frequency management algorithm 114 enable the thermal management algorithm 112 and/or the frequency management algorithm 114 to be adjusted in various ways without departing from the spirit or scope of the described techniques.

Alternatively or additionally, the system 100 supports receiving input 126 from one or more application 128 to adjust the thermal management algorithm 112 and/or the frequency management algorithm 114. In one or more variations, for instance, an application 128 includes configuration settings which specify parameters to which to adjust the thermal management algorithm 112 or the frequency management algorithm 114 for optimal performance of the application 128. Alternatively or in addition, an application 128 includes configuration settings which specify parameters to which to adjust the thermal management algorithm 112 or the frequency management algorithm 114 for optimal performance of particular workloads, e.g., on a workload-by-workload basis and/or on a type of workload basis. In one example, for instance, a computer game application includes settings that specify a first set of parameters to which to adjust the thermal management algorithm 112 or the frequency management algorithm 114 for graphics rendering and a second set of parameters at which to adjust the thermal management algorithm 112 or the frequency management algorithm 114 for game physics. In scenarios where an application 128 provides the input 126 to adjust the thermal management algorithm 112 or the frequency management algorithm 114, for example, the application 128 provides an instruction to the processor 102 to adjust the thermal management algorithm 112 or the frequency management algorithm 114.

Although not depicted in the illustrated example, in one or more variations, the system manager 110 or some other component of the system 100 stores or otherwise maintains one or more profiles for adjusting the thermal management algorithm 112 or the frequency management algorithm 114. By way of example, each profile corresponds to one or more workloads and includes an indication of respective parameters to which to adjust the thermal management algorithm 112 or the frequency management algorithm 114 when those one or more workloads are executed or otherwise performed by the system 100. Thus, when the one or more workloads are detected, the system manager 110 adjusts the thermal management algorithm 112 and/or the frequency management algorithm 114 automatically to have the respective parameters specified in the profile. In one or more implementations, such profiles are created based on user input, based on input from one or more of the application(s) 128, based on adjustments selected based on execution of the calibration workload, and/or obtained from another source (e.g., default settings downloadable from a manufacturer of at least one portion of the system or a provider of an operating system). In at least one variation, the processor 102, the memory 104, and optionally the additional hardware component(s) 118 are operable to implement an operating system (not shown), which is capable of providing input 126 to adjust the thermal management algorithm 112 or the frequency management algorithm 114, e.g., in a similar manner as one or more of the application(s) 128.

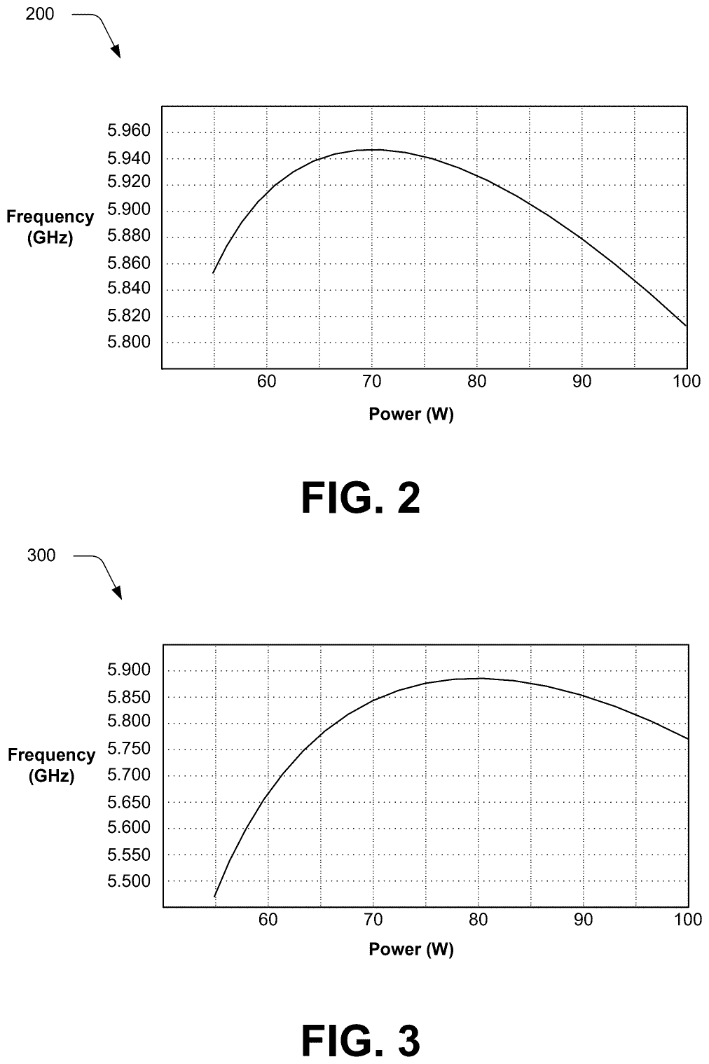

FIGS. 2, 3, and 4 depict non-limiting example diagrams of clock frequency responses measured against power supplied to a component executing a calibration workload under different operating conditions.

For the sake of example, consider a scenario where the processor 102 is used to execute a calibration workload (e.g., tunable worst case test pattern, binary test pattern, etc.) under a first operating condition (a default ambient temperature), a second operating condition (10 degrees Celsius higher than the default ambient temperature), and a third operating condition (10 degrees Celsius lower than the default ambient temperature). In this scenario, during execution of the calibration workload, the system manager 110 adjusts the tunable parameters 116 iteratively across a range of predefined values such as, for instance, maximum voltage (Vmax) values corresponding to a supplied power values between 55 Watts (W) and 100 W. In this scenario, the system manager 110 logs steady state clock frequencies measured during the workload when each of the Vmax values is applied to the thermal management algorithm 112 and/or the frequency management algorithm 114 to determine the frequency response curves illustrated in the diagrams 200 (for the first operating condition), 300 (for the second operating condition), and 400 (for the third operating condition).

For example, as illustrated in diagram 200, an optimal Vmax value (about 1.382 V), which corresponds to a supplied power of about 70 W, can be selected for operating the processor 102 at the highest maximum clock frequency (about 5.95 GHZ) when the ambient temperature is the default ambient temperature. Further, in the illustrated example of diagram 300, an optimal Vmax value (about 1.367 V), which corresponds to a supplied power of about 80 W, can be selected for operating the processor 102 at the highest maximum clock frequency (about 5.87 GHz) possible when the ambient temperature is 10 degrees warmer than the default ambient temperature. Further, in the illustrated example of diagram 400, an optimal Vmax value (about 1.386 V), which corresponds to a supplied power of about 60 W, can be selected for operating the processor 102 at the highest maximum clock frequency (about 5.98 GHZ) possible when the ambient temperature is 10 degrees cooler than the default ambient temperature.

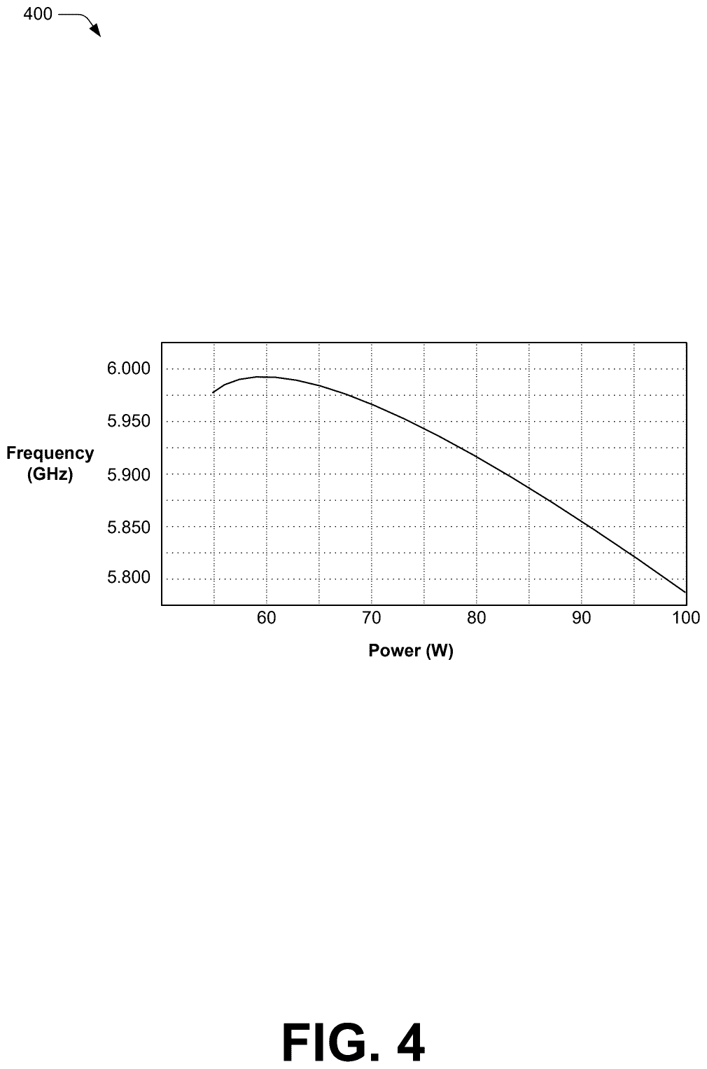

As noted above, under conventional approaches, a default frequency response (corresponding to diagram 200) estimated for the default ambient temperature may be hard-coded in the tuning parameters 116 and therefore applied by the thermal management algorithm 112 and/or the frequency management algorithm 114 regardless of the actual ambient temperature. For instance, if the system manager 110 uses an AVFS technique to improve energy efficiency under the assumption that the optimal Vmax is 1.382V, the processor 102 may actually end up operating at a lower clock frequency and higher power consumption if the actual ambient temperature is higher or lower than the default ambient temperature. This is because a Vmax value of 1.382V corresponds to a power that is less than 80 W in diagram 300 and more than 60 W in diagram 400. Furthermore, if the AVFS process relies on the slope of the frequency curve depicted in FIG. 2 (e.g., positive maximum frequency change between 55 W and 70 W; and diminishing or worse clock frequency changes beyond 70 W), the system manager 110 will experience less accurate and/or fine-tuned control of clock frequencies when the ambient temperature is higher (FIG. 3) or lower (FIG. 4) than the assumed default ambient temperature (FIG. 2).

In contrast to conventional approaches however, the described techniques enable the thermal management algorithm 112 and/or the frequency management algorithm 114 to achieve more accurate and/or more optimal performance versus energy efficiency management by updating the tuning parameters 116 to correspond to the actual frequency response curves depicted in FIG. 3 and/or FIG. 4 or other frequency response curves determined based on the current actual ambient temperature of the processor 102.

It is noted that similar processes can be employed to retune other tuning parameters 116 in addition to or instead of the frequency response curve parameters described above. In an example, a similar temperature versus power response curve can be determined and applied as an updated tuning parameter 116. In another example, controller coefficients (e.g., proportional-derivative (PD) controller coefficients, proportional-integral-derivative (PID) controller coefficients, etc.) can be similarly fine-tuned by the system manager 110. In another example, hysteresis thresholds (e.g., thresholds used to distinguish an analog voltage measurement as a logic high or logic low signal) can similarly be re-tuned.

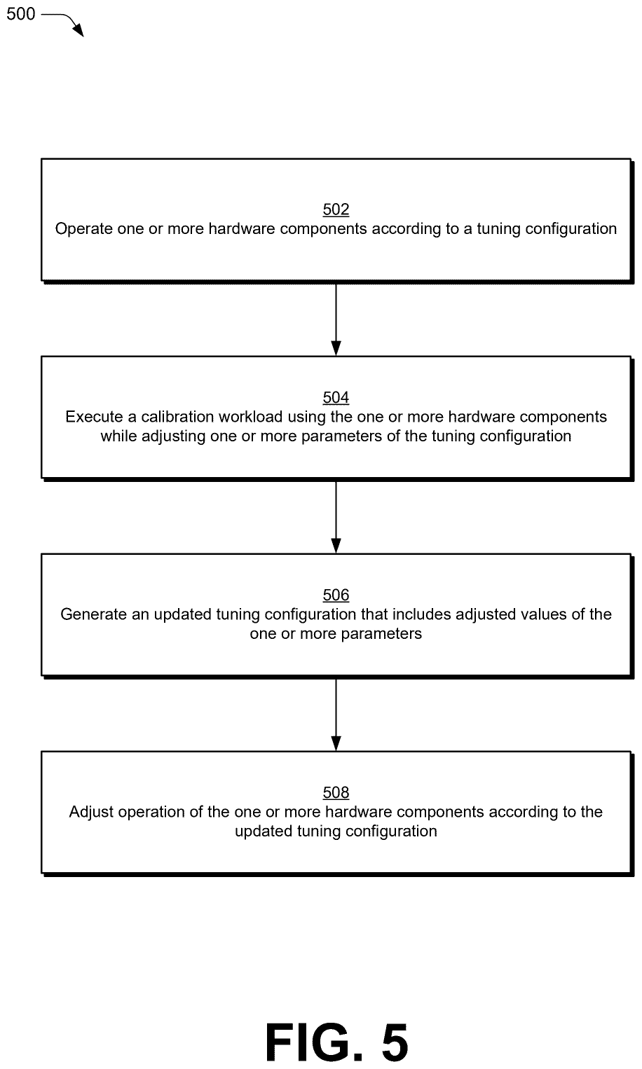

FIG. 5 depicts a procedure in an example implementation 500 of run time firmware calibration.

At block 502, a system manager 110 operates one or more hardware components (e.g., processor 102, memory 104, additional hardware component(s) 118) according to a tuning configuration (e.g., default values or previously stored values of tuning parameters 116). At block 504, the system manager 110 executes a calibration workload using the one or more hardware components while adjusting (e.g., iteratively, etc.) one or more parameters (e.g., tuning parameters 116) of the tuning configuration. In an example, the system manger 110 collects sensor readings (e.g., temperatures, voltages, frequencies, etc.) during the execution of the calibration workload for each adjusted value of the one or more parameters. At block 506, the system manager 110 generates an updated tuning configuration that includes adjusted values of the one or more parameters. In an example, the adjusted values of the one or more parameters are selected for the updated tuning configuration based on the sensor readings. For instance, an optimal Vmax value at which the frequency management algorithm 114 achieved the highest clock frequency measurement may be selected as the updated Vmax value in the updated tuning parameters 116.

Operation of the one or more hardware components is adjusted based on the updated tuning configuration (block 508). By way of example, the system manager 110 computes one or more adjustments for the tuning parameters 116 used by the thermal management algorithm 112 and/or the frequency management algorithm 114 which enables a higher clock frequency and/or reduced energy consumption by the one or more hardware components; and saves these adjustments as updated values of the tuning parameters 116. Examples of such adjustments include, for instance, throttling one or more of voltage, frequency, timings, and so on, for one or more components of the system 100.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the memory 104, the controller 108, and the core 106) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
one or more hardware components including a processor; and
a system manager, the system manager configured to:
operate the one or more hardware components according to a tuning configuration;
execute, using the one or more hardware components, a calibration workload while adjusting one or more parameters of the tuning configuration;
generate an updated tuning configuration that includes adjusted values of the one or more parameters; and
operate the one or more hardware components according to the updated tuning configuration.

2. The system of claim 1, wherein the system manager is further configured to adjust, during execution of the calibration workload, the one or more parameters to values within a predefined range.

3. The system of claim 1, wherein the one or more hardware components include a memory.

4. The system of claim 1, wherein the one or more parameters include at least one of a controller coefficient, a voltage limit, a hysteresis threshold, or an efficiency response.

5. The system of claim 1, further comprising a sensor coupled to the one or more hardware components, wherein the system is further configured to:
based on measurements from the sensor collected during execution of the calibration workload, select the adjusted values of the one or more parameters for the updated tuning configuration.

6. The system of claim 5, wherein the sensor includes a temperature sensor configured to measure a temperature of the processor.

7. The system of claim 1, wherein the system manager is further configured to:
detect a change to a configuration of the one or more hardware components; and
trigger execution of the calibration workload in response to detecting the change.

8. The system of claim 1, further comprising a sensor configured to measure an environment of the system, wherein the system manager is further configured to:
based on measurements from the sensor, detect a change in an environmental condition associated with the tuning configuration; and
schedule execution of the calibration workload based on the change in the environmental condition exceeding a threshold.

9. A method comprising:
operating one or more hardware components according to a tuning configuration;
executing a calibration workload using the one or more hardware components while adjusting one or more parameters of the tuning configuration;
generating an updated tuning configuration that includes adjusted values of the one or more parameters; and
adjusting operation of the one or more hardware components according to the updated tuning configuration.

10. The method of claim 9, further comprising:
receiving input indicative of a request to update the tuning configuration; and
trigger execution of the calibration workload in response to receipt of the input.

11. The method of claim 9, further comprising:
during execution of the calibration workload, adjusting the one or more parameters to values within a predefined range.

12. The method of claim 11, wherein the one or more hardware components include a memory, the memory storing an indication of the predefined range.

13. The method of claim 9, wherein the one or more parameters include at least one of a controller coefficient, a voltage limit, a hysteresis threshold, or an efficiency response.

14. The method of claim 9, further comprising:
based on sensor measurements collected from a sensor during execution of the calibration workload, selecting the adjusted values of the one or more parameters for the updated tuning configuration.

15. The method of claim 14, wherein the sensor includes a temperature sensor configured to measure temperature of the one or more hardware components.

16. The method of claim 9, further comprising:
detecting a change to a configuration of the one or more hardware components; and
scheduling execution of the calibration workload in response to detecting the change.

17. The method of claim 9, further comprising:
based on measurements from a sensor, detecting a change in an environmental condition associated with the tuning configuration; and
scheduling execution of the calibration workload based on the change in the environmental condition exceeding a threshold.

18. A device comprising:
a processor;
a memory; and
a system manager configured to:
operate at least one of the processor or the memory according to a tuning configuration;
execute, using the at least one of the processor or the memory, a calibration workload while adjusting one or more parameters of the tuning configuration;
generate an updated tuning configuration that includes adjusted values of the one or more parameters; and
adjust operation of the at least one of the processor or the memory according to the updated tuning configuration.

19. The device of claim 18, wherein the system manager is further configured to:
during execution of the calibration workload, adjust the one or more parameters to values within a predefined range.

20. The device of claim 18, wherein the one or more parameters include at least one of a controller coefficient, a voltage limit, a hysteresis threshold, or an efficiency response.
